(19) United States
(12) Patent Application Publication
(10) Pub. No.: US 2026/0183742 A1
(43) Pub. Date: Jul. 2, 2026

(54) COMPOSITE MATERIAL, PREPARATION METHOD THEREOF, AND HETEROATOMS-REMOVING METHOD USING THE SAME

(71) Applicant: INDUSTRIAL TECHNOLOGY RESEARCH INSTITUTE, Hsinchu (TW)

(72) Inventors: Jyun-Yi YEH, New Taipei City (TW); Nai-Chia CHENG, New Taipei City (TW); Chao-Huang CHEN, Hsinchu City (TW)

(73) Assignee: INDUSTRIAL TECHNOLOGY RESEARCH INSTITUTE, Hsinchu (TW)

(21) Appl. No.: 19/004,986

(22) Filed: Dec. 30, 2024

(51) Int. Cl. B01J 20/22; C10G 25/12

(52) U.S. Cl. CPC B01J 20/226; C10G 25/12; B01J 2220/46; C10G 2300/1003; C10G 2300/202

(57) ABSTRACT

A composite material, including: a metal oxide support, a metal organic framework, and an interface crystalline layer disposed between the metal oxide support and the metal organic framework, wherein the interface crystalline layer has a d-spacing of 0.290 nm to 0.360 nm. In addition, the present disclosure also provides a preparation method thereof and a heteroatom-removing method using the same.

### BACKGROUND

### 1. Technical Field

The technical field relates to a composite material, a preparation method thereof, and a heteroatom-removing method, and in particular it relates to a composite material in which a metal organic framework is loaded on a metal oxide support, a preparation method thereof, and a heteroatom-removing method using the same.

### 2. Related Art

Compounds in a waste plastic pyrolysis oil often contain heteroatoms such as sulfur, phosphorus, halogens, and silicon. These heteroatom impurities limit the application of waste plastic pyrolysis oil as an additive feedstock for light oil cracking. Sulfur, phosphorus, and halogens are also common heteroatoms in a crude oil. Currently, commercial adsorbents (such as, aluminium oxide) can remove some of the aforementioned heteroatoms, but they are not effective in removing organic silicon contaminants.

Metal organic frameworks (MOFs) possess both a metallic and an organic structure; which allow them to adsorb and remove the organic silicon impurities (for example, siloxane) from waste plastic pyrolysis oil through their unique metal-organic combined structure.

In addition to the waste plastic pyrolysis oil, other liquid organic matters (for example, biomass, food, and waste) also require effective heteroatom adsorbents to remove the heteroatoms (for example, nitrogen) for improved applicability.

### SUMMARY

One embodiment of the disclosure provides a composite material including a metal oxide support, a metal organic framework, and an interface crystalline layer between the metal oxide support and the metal organic framework, wherein the interface crystalline layer has a d-spacing of 0.290 nm to 0.360 nm.

Another embodiment of the disclosure provides a composite material preparation method, and the method includes adding a metal oxide support into a base solution at a first temperature and a pressure to form a first mixed solution; introducing an organic ligand (derived from an organic linking agent) and a metal ion precursor into the first mixed solution at the first temperature and the pressure, to react and form a second mixed solution; filtering the second mixed solution to obtain a solid product; and drying the solid product at a second temperature and a pressure (which may be the same as the pressure of forming the first mixed solution) to obtain the composite material, wherein the second temperature is higher than the first temperature.

Yet another embodiment of the disclosure provides a method for removing heteroatom from a liquid organic matter (for example, a waste plastic pyrolysis oil, a liquid biomass, a liquid food, a liquid waste) using the composite material, and the method includes filling a reactor with the composite material in an embodiment of the present disclosure; introducing a heteroatom-containing liquid organic matter into the reactor; and adsorbing heteroatom in the liquid organic matter by contacting the composite material with the heteroatom-containing liquid organic matter, wherein the heteroatom include silicon, phosphorus, bromine, chlorine, nitrogen or a combination thereof.

### BRIEF DESCRIPTION OF THE DRAWINGS

FIG. 1 is a TEM image of a composite material according to one embodiment of the disclosure.

FIG. 2 is the TEM image of the composite material according to another embodiment of the disclosure.

FIG. 3 is the TEM image of the composite material according to yet another embodiment of the disclosure.

FIG. 4 is the TEM image of an adsorbent of a comparative example.

A detailed description is given in the following embodiments.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

Below, the composite material of the disclosure is described with reference to the drawings.

One embodiment of the disclosure provides a composite material including a metal oxide support, a metal organic framework, and an interface crystalline layer between the metal oxide support and the metal organic framework, wherein the interface crystalline layer, as analyzed by high-resolution TEM, exhibits a d-spacing of 0.290 nm to 0.360 nm. The interface crystalline layer may have a thickness of 10 nm to 340 nm. In some embodiments of the disclosure, the interface crystalline layer may partially cover the metal oxide support.

In some embodiments of the disclosure, the metal oxide support may include aluminium oxide, zirconium oxide, cerium oxide, or a combination thereof. In some embodiments, the metal oxide support may have a non-porous structure with a median particle size of 10 μm to 150 μm. In some embodiments, the metal oxide support may have a porous structure with a pore size of 10 nm to 180 nm, a specific surface area of 1 m²/g to 500 m²/g, and a pore volume of 0.002 cm³/g to 0.3 cm³/g.

In some embodiments of the disclosure, the metal organic framework may include a metal ion; and an organic ligand, wherein the metal of the metal ion is selected from copper, aluminum, iron, zinc, or a combination thereof, which may be introduced by a metal ion precursor. Also, the organic ligand includes at least one benzene ring and at least two carboxyl groups, which may be introduced by an organic linking agent.

In some embodiments of the disclosure, the organic ligand may include at least one amino group. In some embodiments of the disclosure, the organic ligand may not include an amino group. In some embodiments of the disclosure, the organic ligand is derived from the organic linking agent, and the organic linking agent may include trimesic acid (BTC), 2-aminoterephthalic acid (BDC-NH₂), or a combination thereof.

In some embodiments of the disclosure, a weight ratio of the metal organic framework to the composite material may be 0.1:100 to 50:100.

Some embodiments of the disclosure provide a composite material preparation method. The method includes adding a metal oxide support into a base solution at a first temperature and a pressure to form a first mixed solution; introducing an organic linking agent and a metal ion precursor into the first mixed solution to react and form a second mixed solution at a first temperature and a pressure; filtering the second mixed solution to obtain the composite material of the disclosure. In addition, the solid product may also be dried at a second temperature and a pressure to obtain the composite material, wherein the second temperature is higher than the first temperature. In some embodiments of the disclosure, the first temperature may be room temperature or may range from 15° C. to 50° C., the second temperature may range from 60° C. to 90° C., and the pressure may range from 0.5 bar to 10 bar. In some embodiments of the disclosure, the metal oxide includes aluminium oxide, zirconium oxide, cerium oxide, or a combination thereof. In some embodiments of the disclosure, the metal ion precursor may be a copper salt (for example, copper nitrate), an aluminum salt (for example, aluminum nitrate), an iron salt (for example, iron nitrate), a zinc salt (for example, zinc nitrate), or a combination thereof. In some embodiments of the disclosure, the metal organic framework may be crystallized on the surface of the metal oxide support, thereby forming an interface crystalline layer with a specified-spacing.

In some embodiments of the disclosure, the organic linking agent may include trimesic acid (BTC), 2-aminoterephthalic acid (BDC-NH₂), or a combination thereof.

In some embodiments of the disclosure, the molar ratio of the metal oxide support to the metal ion precursor may be 1:20 to 1:500. In some embodiments of the disclosure, the molar ratio of the metal ion precursor to the organic linking agent may be 77:100 to 1:1.

The composite material of the disclosure, employs a metal oxide as a support and by loading and appropriately dispersing the metal organic frameworks through the interface crystalline layer, thereby reducing the mass transfer barrier of the metal organic framework, so as to effectively enhance the adsorption of heteroatom and thus remove the heteroatom.

One embodiment of the disclosure provides a method for removing heteroatom from a liquid organic matter using the composite material. The method includes filling a reactor with the composite material of the disclosure; introducing a heteroatom-containing liquid organic matter into the reactor; and adsorbing the heteroatom in the heteroatoms-containing liquid organic matter by contacting the composite material with the heteroatom-containing liquid organic matter. The heteroatom includes silicon, phosphorus, bromine, chlorine, nitrogen or a combination thereof.

In some embodiments of the disclosure, the above method for removing the heteroatom from the liquid organic matter may be conducted at room temperature or at a temperature of 15° C. to 30° C., and at a pressure of 1 bar. In some embodiments of the disclosure, the liquid organic matter may include a waste plastic pyrolysis oil, a liquid biomass, a liquid food, a liquid waste or a combination thereof. In some embodiments of the disclosure, the composite material exhibits a silicon adsorption capacity of 49 to 151 μg/g.

In one embodiment of the disclosure, the above method may further includes washing the composite material by bringing the composite material into contact with an organic solvent; and refilling the composite material back into the reactor.

In some embodiments of the disclosure, the organic solvent used to wash the composite material may include tetrahydrofuran, methanol, ethanol, toluene, or acetone. By washing the composite material having adsorbed heteroatom with the organic solvent, the adsorption capacity of the composite material may be regenerated for reuse, which is beneficial for cost reduction and sustainable development.

To make the foregoing aspects and other objectives, features, and advantages of the disclosure more apparent and understandable, the following examples are provided with reference to the accompanying drawings for a detailed description.

### Materials and Preparation Methods

In the following examples and comparative examples, the aluminium oxide (Al₂O₃) used is purchased from ACROS, having a specific surface area of 23 m²/g, a pore size of 175 nm, a median particle size of 10 μm, a pore volume of 0.12 cm³/g, and a crystalline phase of γ-phase.

In the following examples and comparative examples, the zirconium oxide (ZrO₂) used is purchased from Sigma-Aldrich, having a specific surface area of 81.1 m²/g, a pore size of 12.7 nm, a median particle size of 15 μm, a pore volume of 0.266 cm³/g, and a crystalline phase of tetragonal form.

In the following examples and comparative examples, the cerium oxide (CeO₂) used is purchased from Sigma-Aldrich, having a specific surface area of 8.2 m²/g, a pore size of 23.6 nm, a median particle size of 12 μm, a pore volume of 0.05 cm³/g, and a crystalline phase of cubic form.

In the following examples and comparative examples, the trimesic acid (BTC) used is purchased from Sigma-Aldrich.

In the following examples and comparative examples, the 2-aminoterephthalic acid (BDC-NH₂) used is purchased from Sigma-Aldrich.

### Example 1 (Al-BTC@Al₂O₃)

0.8 g of sodium hydroxide (NaOH) was dissolved in 60 mL of water to prepare a base solution. Then, 9 g of aluminium oxide was added into the base solution and stirred at room temperature under a pressure of 1 bar for 0.1 hour. Next, 1.12 g of trimesic acid was added and stirred for 1 hour to form a solid-liquid mixture. Subsequently, 2.83 g of an aluminum nitrate solution (dissolved in 64.8 mL of water) was dropwise added to the solid-liquid mixture and stirred for 24 hours. The reaction mixture was then filtered to obtain a crude product, which was washed several times with deionized water to remove residual impurities. Finally, the crude product was dried at 80° C. under the pressure of 1.0 bar to obtain the final product.

### Example 2 (Cu-BDC-NH₂@Al₂O₃)

0.596 g of sodium hydroxide (NaOH) was dissolved in 50 mL of water to prepare a base solution. Then, 9 g of aluminium oxide (Al₂O₃) was added into the base solution and stirred at room temperature under a pressure of 1.0 bar for 0.1 hour. Next, 1.0 g of 2-aminoterephthalic acid was added and stirred for 1 hour to form a solid-liquid mixture. Subsequently, 1.335 g of a copper nitrate solution (dissolved in 8.0 mL of water) was dropwise added to the solid-liquid mixture and stirred for 24 hours. The reaction mixture was then filtered to obtain a crude product, which was washed several times with deionized water to remove residual impurities. Finally, the crude product was dried at 80° C. under the pressure of 1.0 bar to obtain the final product.

### Example 3 (Fe-BDC-NH₂@Al₂O₃)

1.7898 g of sodium hydroxide (NaOH) was dissolved in 150 mL of water to prepare a base solution. Then, 27 g of aluminium oxide was added into the base solution and stirred at room temperature under the pressure of 1 bar for 0.1 hour. Next, 3.0 g of 2-aminoterephthalic acid was added and stirred for 1 hour to form a solid-liquid mixture. Subsequently, 6.69 g of an iron nitrate solution (dissolved in 24.0 mL of water) was dropwise added to the solid-liquid mixture and stirred for 24 hours. The reaction mixture was then filtered to obtain a crude product, which was washed several times with deionized water to remove residual impurities. Finally, the crude product was dried at 80° C. under the pressure of 1.0 bar to obtain the final product.

### Example 4 (Al-BTC@ZrO₂)

0.8 g of sodium hydroxide (NaOH) was dissolved in 60 mL of water to prepare a base solution. Then, 9 g of zirconium oxide (ZrO₂) was added into the base solution and stirred at room temperature under a pressure of 1.0 bar for 0.1 hour. Next, 1.12 g of trimesic acid was added and stirred for 1 hour to form a solid-liquid mixture. Subsequently, 2.83 g of an aluminum nitrate solution (dissolved in 64.8 mL of water) was dropwise added to the solid-liquid mixture and stirred for 24 hours. The reaction mixture was then filtered to obtain a crude product, which was washed several times with deionized water to remove residual impurities. Finally, the crude product was dried at 80° C. under the pressure of 1.0 bar to obtain the final product.

### Example 5 (Cu-BDC-NH₂@CeO₂)

0.596 g of sodium hydroxide (NaOH) was dissolved in 50 mL of water to prepare a base solution. Then, 9 g of cerium oxide (CeO₂) was added to the base solution and stirred at room temperature under a pressure of 1.0 bar for 0.1 hour. Next, 1.0 g of 2-aminoterephthalic acid was added and stirred for 1 hour to form a solid-liquid mixture. Subsequently, 1.335 g of a copper nitrate solution (dissolved in 8.0 mL of water) was dropwise added to the solid-liquid mixture and the reaction was stirred for 24 hours. The reaction mixture was then filtered to obtain a crude product, which was washed several times with deionized water to remove residual substances. Finally, the crude product was dried at 80° C. under the pressure of 1.0 bar to obtain the final product.

### Example 6 (Zn-BDC-NH₂@CeO₂)

0.596 g of sodium hydroxide (NaOH) was dissolved in 50 mL of water to prepare a base solution. Then, 9 g of cerium oxide (CeO₂) was added to the base solution and stirred at room temperature under a pressure of 1.0 bar for 0.1 hour. Next, 1.0 g of 2-aminoterephthalic acid was added and stirred for 1 hour to form a solid-liquid mixture. Subsequently, 1.664 g of a zinc nitrate solution (dissolved in 8.0 mL of water) was dropwise added to the solid-liquid mixture and stirred for 24 hours. The reaction mixture was filtered to obtain a crude product, which was washed several times with deionized water to remove residual substances. Finally, the crude product was dried at 80° C. under the pressure of 1.0 bar to obtain the final product.

### Example 7 (Cu-BDC-NH₂@Al₂O₃)

The same preparation conditions as described in Example 2 of the disclosure are employed, except that the amount of 2-aminoterephthalic acid was adjusted to 0.16 g, and the amount of copper nitrate was adjusted to 0.2136 g.

### Example 8 (Cu-BDC-NH₂@Al₂O₃)

The same preparation conditions as described in Example 2 of the disclosure are employed, except that the amount of 2-aminoterephthalic acid was adjusted to 0.65 g, and the amount of copper nitrate was adjusted to 0.868 g.

### Example 9 (Cu-BDC-NH₂@Al₂O₃)

The same preparation conditions as described in Example 2 of the disclosure are employed, except that the amount of 2-aminoterephthalic acid was adjusted to 3.0 g, and the amount of copper nitrate was adjusted to 4.01 g.

### Example 10 (Cu-BDC-NH₂@Al₂O₃)

The same preparation conditions as described in Example 2 of the disclosure are employed, except that the amount of 2-aminoterephthalic acid was adjusted to 5.0 g, and the amount of copper nitrate was adjusted to 6.68 g.

### Example 11 (Cu-BDC-NH₂@Al₂O₃)

The same preparation conditions as described in Example 2 of the disclosure are employed, except that the amount of 2-aminoterephthalic acid was adjusted to 20.0 g, and the amount of copper nitrate was adjusted to 26.7 g.

### Example 12 (Cu-BDC-NH₂@Al₂O₃)

The same preparation conditions as described in Example 2 of the disclosure are employed, except that the amount of 2-aminoterephthalic acid was adjusted to 50.0 g, and the amount of copper nitrate was adjusted to 66.8 g.

### Comparative Example 1 (Al₂O₃)

The aluminium oxide purchased from ACROS was used as adsorbent I.

### Comparative Example 2 (Al-BTC)

0.8 g of sodium hydroxide (NaOH) was dissolved in 60 mL of water to prepare a base solution. Next, 1.12 g of trimesic acid was added and stirred at room temperature under a pressure of 1.0 bar for 0.1 hour to form a solid-liquid mixture. Then, 2.83 g of an aluminum nitrate solution (dissolved in 64.8 mL of water) was dropwise added to the solid-liquid mixture and stirred for 24 hours at room temperature under the pressure of 1.0 bar. The reaction mixture was filtered to obtain a crude product, which was washed several times with deionized water to remove residual substances. Finally, the crude product was dried at 80° C. under the pressure of 1.0 bar to obtain the final product (adsorbent II).

### Comparative Example 3 (Cu-BDC-NH₂)

0.596 g of sodium hydroxide (NaOH) was dissolved in 50 mL of water to prepare a base solution. Next, 1.0 g of 2-aminoterephthalic acid was added and stirred at room temperature under a pressure of 1.0 bar for 0.1 hour to form a mixture. Then, 2.446 g of a copper nitrate solution (dissolved in 8.0 mL of water) was dropwise added to the solid-liquid mixture and stirred for 24 hours at room temperature under the pressure of 1.0 bar. The mixture was filtered to obtain a crude product, which was washed several times with deionized water to remove residual substances. Finally, the crude product was dried at 80° C. under the pressure of 1.0 bar to obtain the final product (adsorbent III).

### Comparative Example 4 (Fe-BDC-NH₂)

1.7898 g of sodium hydroxide (NaOH) was dissolved in 150 mL of water to prepare a base solution. Next, 3.0 g of 2-aminoterephthalic acid was added and stirred at room temperature under a pressure of 1.0 bar for 1 hour to form a mixture. Then, 6.69 g of an iron nitrate solution (dissolved in 24.0 mL of water) was dropwise added to the solid-liquid mixture and stirred for 24 hours at room temperature under the pressure of 1.0 bar. The reaction mixture was filtered to obtain a crude product, which was washed several times with deionized water to remove residual substances. Finally, the crude product was dried at 80° C. under the pressure of 1.0 bar to obtain the final product (adsorbent IV).

### Comparative Example 5 (Al-BTC+Al₂O₃)

1.00 g of adsorbent II was physically mixed with 99.0 g of adsorbent I.

### Comparative Example 6 (Cu-BDC-NH₂+Al₂O₃)

1.00 g of adsorbent III was physically mixed with 99.0 g of adsorbent I.

### Comparative Example 7 (Fe-BDC-NH₂+Al₂O₃)

1.00 g of adsorbent IV was physically mixed with 99.0 g of adsorbent I.

### Comparative Example 8 (Acid-synthesized Al-BTC@Al₂O₃)

9.0 g of Al₂O₃ was dissolved in 20 mL of 1 M HNO₃ to prepare an acid solution, which was stirred at room temperature under a pressure of 1.0 bar for 0.1 hour. Next, 1.12 g of trimesic acid was added and stirred for 1 hour to form a solid-liquid mixture. Then, 2.83 g of an aluminum nitrate solution (dissolved in 64.8 mL of water) was dropwise added to the solid-liquid mixture and stirred for 24 hours at room temperature under the pressure of 1.0 bar. The reaction mixture was filtered to obtain a crude product, which was washed several times with deionized water to remove residual substances. Finally, the crude product was dried at 80° C. under the pressure of 1.0 bar to obtain the final product.

### Comparative Example 9 (Acid-Synthesized Cu-BDC-NH₂@Al₂O₃)

9.0 g of Al₂O₃ was dissolved in 20 mL of 1 M HNO₃ to prepare an acid solution, which was stirred at room temperature under a pressure of 1.0 bar for 0.1 hour. Next, 1.0 g of 2-aminoterephthalic acid was added and stirred for 1 hour to form a solid-liquid mixture. Then, 1.335 g of a copper nitrate solution (dissolved in 8.0 mL of water) was dropwise added to the solid-liquid mixture and stirred for 24 hours at room temperature under the pressure of 1.0 bar. The reaction mixture was filtered to obtain a crude product, which was washed several times with deionized water to remove residual substances. Finally, the crude product was dried at 80° C. under the pressure of 1.0 bar to obtain the final product.

### Comparative Example 10 (Acid-Synthesized Fe-BDC-NH₂@Al₂O₃)

9.0 g of Al₂O₃ was dissolved in 20 mL of 1 M HNO₃ to prepare an acid solution, which was stirred at room temperature under a pressure of 1.0 bar for 0.1 hour. Next, 3.0 g of 2-aminoterephthalic acid was added and stirred for 1 hour to form a solid-liquid mixture. Then, 6.68 g of an iron nitrate solution (dissolved in 24.0 mL of water) was dropwise added to the solid-liquid mixture and stirred for 24 hours at room temperature under the pressure of 1.0 bar. The reaction mixture was filtered to obtain a crude product, which was washed several times with deionized water to remove residual substances. Finally, the crude product was dried at 80° C. under the pressure of 1.0 bar to obtain the final product.

### Comparative Example 11 (ZrO₂)

Zirconium oxide purchased from Sigma-Aldrich was used as adsorbent V.

### Comparative Example 12 (Al-BTC+ZrO₂)

1.00 g of adsorbent II was physically mixed with 99.0 g of adsorbent V.

### Comparative Example 13 (CeO₂)

Cerium oxide purchased from Sigma-Aldrich was used as adsorbent VI.

### Comparative Example 14 (Cu-BDC-NH₂+CeO₂)

1.00 g of adsorbent III was physically mixed with 99.0 g of adsorbent VI.

### Comparative Example 15 (Zn-BDC-NH₂)

0.596 g of sodium hydroxide (NaOH) was dissolved in 50 mL of water to prepare a base solution. Next, 1.0 g of 2-aminoterephthalic acid was added and stirred at room temperature under a pressure of 1.0 bar for 1 hour to form a mixture. Then, 1.664 g of a zinc nitrate solution (dissolved in 8.0 mL of water) was dropwise added to the solid-liquid mixture and stirred for 24 hours at room temperature under the pressure of 1.0 bar. The mixture was filtered to obtain a crude product, which was washed several times with deionized water to remove residual substances. Finally, the crude product was dried at 80° C. under the pressure of 1.0 bar to obtain the final product (adsorbent VII).

### Comparative Example 16 (Zn-BDC-NH₂+CeO₂)

1.00 g of adsorbent VII was physically mixed with 99.0 g of adsorbent VI.

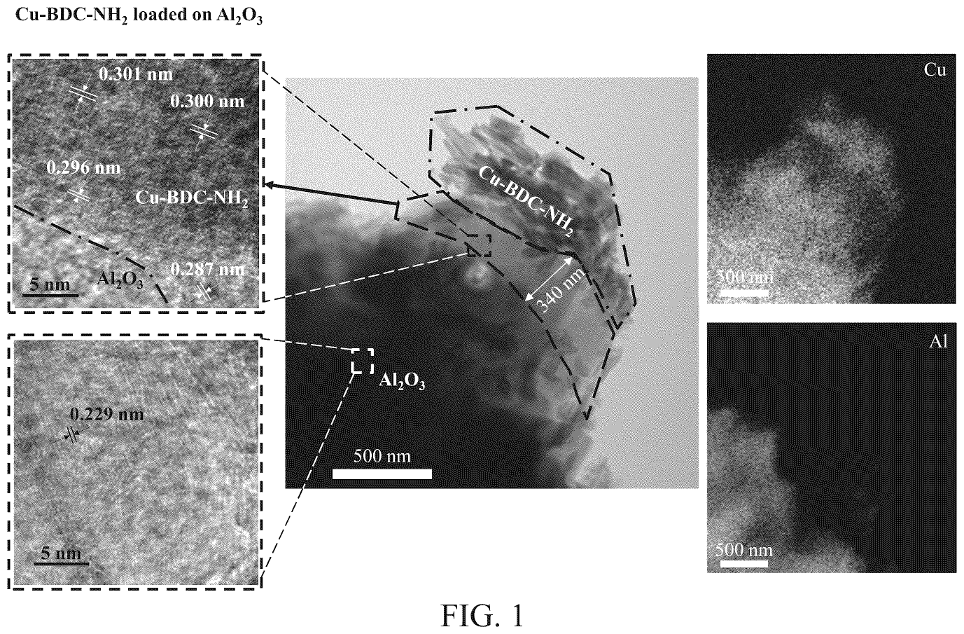

FIG. 1 is a TEM image of the composite material according to one embodiment of the disclosure (Example 2).

Referring to FIG. 1, the composite material of Example 2 includes three portions: pristine Cu-BDC-NH₂, Cu-BDC-NH₂ loaded on Al₂O₃ (interface crystalline layer), and pristine Al₂O₃, wherein the thickness of the interface crystalline layer may reach up to 340 nm in some regions, and its d-spacing is 0.287 nm to 0.301 nm, whereas the d-spacing of Al₂O₃ is 0.229 nm. Although the interface crystalline layer exhibits an ordered crystalline structure, its d-spacing increases gradually from 0.287 nm in regions close to Al₂O₃ to 0.301 nm in regions farther away from Al₂O₃, due to the mismatch in lattice constants between Al₂O₃ and Cu-BDC-NH₂ crystals. Moreover, according to the elemental mapping (Cu, Al) on the right side of FIG. 1, it may be seen that the copper-containing metal organic framework covers at least a portion of the metal oxide support, whereas the aluminium-containing metal oxide support does not noticeably diffuse or grow toward the metal organic framework, Cu-BDC-NH₂.

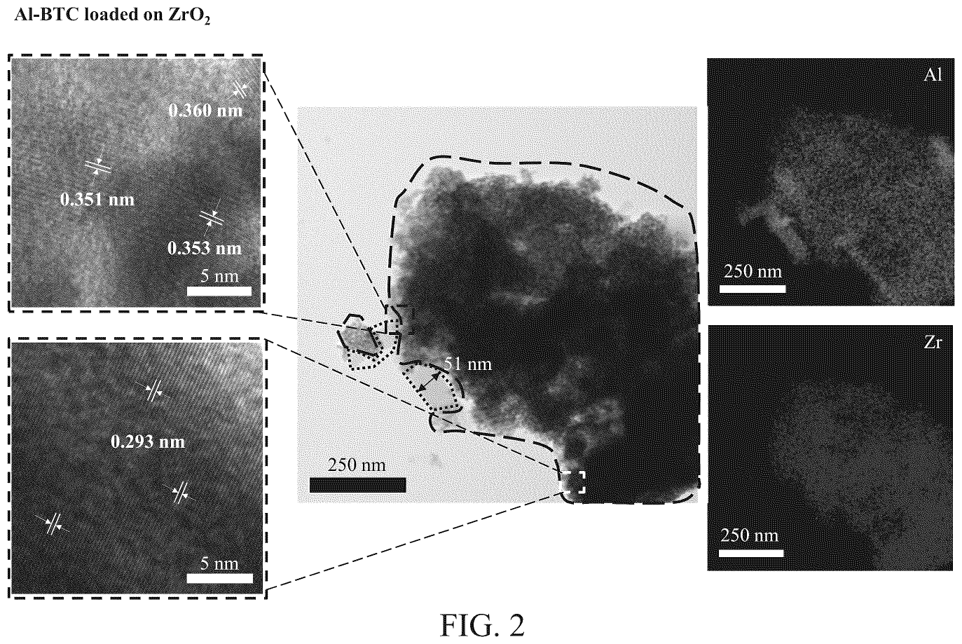

FIG. 2 is a TEM image of the composite material according to one embodiment of the disclosure (Example 4).

Referring to FIG. 2, the composite material of Example 4 comprises three components: pristine Al-BTC, Al-BTC loaded on ZrO₂ (interface crystalline layer), and pristine ZrO₂, wherein the thickness of the interface crystalline layer may reach 51 nm in some regions, and its d-spacing is 0.351 nm to 0.360 nm, whereas the d-spacing of ZrO₂ is 0.293 nm. Although the interface crystalline layer is an ordered crystalline structure, its d-spacing increases gradually from 0.351 nm in regions close to ZrO₂ to 0.360 nm in regions farther away from ZrO₂, due to the mismatch in lattice constants between ZrO₂ and Al-BTC crystals, Moreover, according to the elemental mapping (Al, Zr) on the right side of FIG. 2, it may be seen that the aluminium-containing metal organic framework covers at least a portion of the metal oxide support, whereas the zirconium-containing metal oxide support does not noticeably diffuse or grow toward the metal organic framework, Al-BTC.

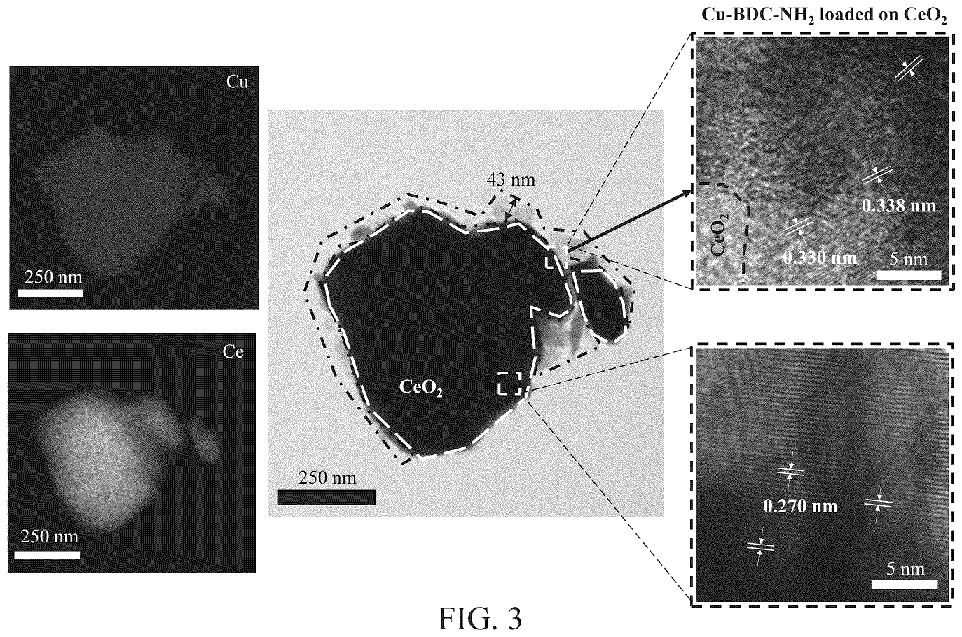

FIG. 3 is a TEM image of the composite material according to one embodiment of the disclosure (Example 5).

Referring to FIG. 3, the composite material of Example 5 comprises three portions: pristine Cu-BDC-NH₂, Cu-BDC-NH₂ loaded on CeO₂ (interface crystalline layer), and pristine CeO₂, wherein the thickness of the interface crystalline layer may reach 43 nm in some regions, and its d-spacing is 0.330 nm to 0.344 nm, whereas the d-spacing of CeO₂ is 0.270 nm. Although the interface crystalline layer is an ordered crystalline structure, its d-spacing increases gradually from 0.330 nm in regions close to the CeO₂ to 0.344 nm in regions farther away from CeO₂, due to the mismatch in lattice constants between CeO₂ and Cu-BDC-NH₂ crystals. Moreover, according to the elemental mapping (Cu, Ce) on the left side of FIG. 3, it may be seen that the copper-containing metal organic framework covers at least a portion of the metal oxide support, whereas the cerium-containing metal oxide support does not noticeably diffuse or grow toward the metal organic framework, Cu-BDC-NH₂.

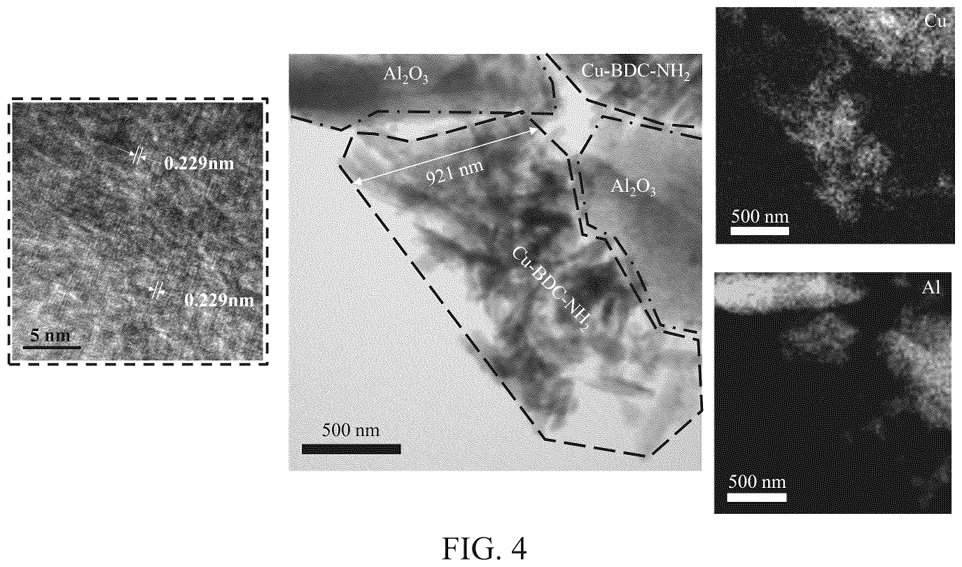

FIG. 4 is a TEM image of the adsorbent of a comparative example (Comparative Example 6) according to the disclosure.

Referring to FIG. 4, the adsorbent of Comparative Example 6, obtained by physical mixing, includes only two portions: pristine Cu-BDC-NH₂ and pristine Al₂O₃. The two portions are separated and do not have an interface crystalline layer. Moreover, according to the elemental mapping (Cu, Al) on the right side of FIG. 4, it may be observed that the copper-containing metal organic framework does not cover the metal oxide.

### Evaluation of Heteroatom Adsorption

9 g of the composite materials of Example 1 to Example 12, and 9 g of the adsorbents of Comparative Example 1 to Comparative Example 16 are respectively placed in a fixed-bed vacuum filtration system. 30 mL of a polypropylene plastic pyrolysis oil is respectively added to each system to conduct heteroatom adsorption tests. The compositions of the products are analyzed by X-ray fluorescence (XRF) and the adsorption capacities (the weight of impurity adsorbed per gram of material) are calculated.

Table 1 below discloses the results of the heteroatom adsorption tests for the materials of the various examples and comparative examples of the disclosure.

TABLE 1

| | | MOF | Silicon | Phosphorus | Halogen | Nitrogen |
|---|---|---|---|---|---|---|
| | | Content | Adsorption | Adsorption | Adsorption | Adsorption |
| | Name | (wt %) | (μg/g) | (μg/g) | (μg/g) | (μg/g) |
| Example 1 | Al- | 1 | 151 | 85.1 | 347 | 410 |
| | BTC@Al₂O₃ | | | | | |
| Example 2 | Cu-BDC- | 1 | 132 | 75.7 | 335 | 463 |
| | NH₂@Al₂O₃ | | | | | |
| Example 3 | Fe-BDC- | 1 | 107 | 85.1 | 312 | 441 |
| | NH₂@Al₂O₃ | | | | | |
| Example 4 | Al- | 1 | 142 | 105.1 | 346 | 371 |
| | BTC@ZrO₂ | | | | | |
| Example 5 | Cu-BDC- | 1 | 112 | 80.1 | 312 | 512 |
| | NH₂@CeO₂ | | | | | |
| Example 6 | Zn-BDC- | 1 | 124 | 110 | 364 | 417 |
| | NH₂@CeO₂ | | | | | |
| Example 7 | Cu-BDC- | 0.1 | 49.1 | 30.2 | 247 | 151 |
| | NH₂@Al₂O₃ | | | | | |
| Example 8 | Cu-BDC- | 0.5 | 80.1 | 54.7 | 311 | 399 |
| | NH₂@Al₂O₃ | | | | | |
| Example 9 | Cu-BDC- | 3 | 110 | 75.2 | 321 | 443 |
| | NH₂@Al₂O₃ | | | | | |
| Example | Cu-BDC- | 5 | 94.1 | 75.2 | 311 | 421 |
| 10 | NH₂@Al₂O₃ | | | | | |
| Example | Cu-BDC- | 20 | 90.2 | 76 | 300 | 411 |
| 11 | NH₂@Al₂O₃ | | | | | |
| Example | Cu-BDC- | 50 | 89.9 | 75.3 | 299 | 350 |
| 12 | NH₂@Al₂O₃ | | | | | |
| Comparative | Al₂O₃ | 0 | 50.2 | 27.2 | 253 | 140 |
| Example 1 | | | | | | |
| Comparative | Al-BTC | 100 | 94.2 | 85.1 | 309 | 210 |
| Example 2 | | | | | | |
| Comparative | Cu-BDC-NH₂ | 100 | 87.9 | 75 | 295 | 321 |
| Example 3 | | | | | | |
| Comparative | Fe-BDC-NH₂ | 100 | 75.3 | 85.1 | 285 | 298 |
| Example 4 | | | | | | |
| Comparative | Al- | 1 | 56.5 | 30.6 | 250 | 141 |
| Example 5 | BTC + Al₂O₃ | | | | | |
| Comparative | Cu-BDC- | 1 | 56.5 | 26.4 | 260 | 152 |
| Example 6 | NH₂ + Al₂O₃ | | | | | |
| Comparative | Fe-BDC- | 1 | 50.2 | 28.9 | 243 | 161 |
| Example 7 | NH₂ + Al₂O₃ | | | | | |
| Comparative | Acid-synthesized | 0.1 | 43.9 | 26.4 | 253 | 142 |
| Example 8 | Al- | | | | | |
| | BTC@Al₂O₃ | | | | | |
| Comparative | Acid-synthesized | 0.2 | 50.2 | 27.2 | 243 | 148 |
| Example 9 | Cu-BDC- | | | | | |
| | NH₂@Al₂O₃ | | | | | |
| Comparative | Acid-synthesized | 0.1 | 50.2 | 28.0 | 246 | 143 |
| Example | Fe-BDC- | | | | | |
| 10 | NH₂@Al₂O₃ | | | | | |
| Comparative | ZrO₂ | 0 | 34.2 | 31.2 | 211 | 121 |
| Example | | | | | | |
| 11 | | | | | | |
| Comparative | Al-BTC + ZrO₂ | 1 | 41.4 | 43.6 | 220 | 140 |
| Example | | | | | | |
| 12 | | | | | | |
| Comparative | CeO₂ | 0 | 25.6 | 29.1 | 250 | 167 |
| Example | | | | | | |
| 13 | | | | | | |
| Comparative | Cu-BDC- | 1 | 32.7 | 34.7 | 278 | 180 |
| Example | NH₂ + CeO₂ | | | | | |
| 14 | | | | | | |
| Comparative | Zn-BDC-NH₂ | 100 | 85.9 | 89 | 312 | 310 |
| Example | | | | | | |
| 15 | | | | | | |
| Comparative | Zn-BDC- | 1 | 35.4 | 38.1 | 277 | 172 |
| Example | NH₂ + CeO₂ | | | | | |
| 16 | | | | | | |

Based on the test results in Table 1, the following phenomena can be observed.

By comparing Example 1 to Example 3 with Comparative Example 1 to Comparative Example 7, it may be confirmed that the composite material of the disclosure exhibits superior silicon adsorption capacity compared to using the metal oxide alone, the metal organic framework alone, or merely physically mixing the two. In addition, the composite material of the disclosure also exhibits excellent adsorption capacities for phosphorus, halogens, and nitrogen. The composite material of the disclosure simultaneously achieves superior adsorption capacities for silicon, phosphorus, halogens, and nitrogen, i.e., it has excellent heteroatom adsorption performance.

By comparing Example 1 to Example 3 with Comparative Example 8 to Comparative Example 10, it may be confirmed that the composite material of the disclosure exhibits superior heteroatom (including silicon, phosphorus, halogens, and nitrogen) adsorption capacity compared to the materials synthesized in an acidic environment. Moreover, it may be seen that the adsorption capacities for various heteroatoms in Comparative Example 8 to Comparative Example 10 are similar to the aluminium oxide in Comparative Example 1. During the preparation of Comparative Example 8 to Comparative Example 10, it was found that the organic ligand is difficult to dissolve in the acidic aqueous solution. Therefore, it is speculated that the metal organic frameworks in Comparative Example 8 to Comparative Example 10 may not have been effectively formed.

By comparing Example 4 with Comparative Example 2, Comparative Example 11, and Comparative Example 12, it may be confirmed that the composite material of the disclosure exhibits superior adsorption capacities for silicon, phosphorus, halogens, and nitrogen compared to using the metal oxide alone, the metal organic framework alone, or merely physically mixture of the two.

By comparing Example 5 with Comparative Example 3, Comparative Example 13, and Comparative Example 14, it may be confirmed that the composite material of the disclosure exhibits superior adsorption capacities for silicon, phosphorus, halogens, and nitrogen compared to using the metal oxide alone, the metal organic framework alone, or merely physically mixture of the two.

By comparing Example 6 with Comparative Example 13, Comparative Example 15, and Comparative Example 16, it may be confirmed that the composite material of the disclosure exhibits superior adsorption capacities for silicon, phosphorus, halogens, and nitrogen compared to using the metal oxide alone, the metal organic framework alone, or merely physically mixture of the two

By comparing Example 2 with Example 7 to Example 12, it may be confirmed that the composite material containing 1 wt % of the metal organic framework (as shown in Example 2) exhibits superior adsorption capacities for silicon, phosphorus, halogens, and nitrogen.

In summary, the disclosure provides a composite material, a preparation method thereof, and a heteroatom removing method, by using the metal oxide as a support to disperse the metal organic framework, thereby achieving the effects of reducing the mass transfer barriers of the metal organic framework and enhancing the adsorption and subsequent removal of heteroatom.

It will be apparent to those skilled in the art that various modifications and variations may be made to the disclosed methods and materials. It is intended that the specification and examples be considered as exemplary only, with the true scope of the disclosure being indicated by the following claims and their equivalents.

What is claimed is:

1. A composite material, comprising:
a metal oxide support;
a metal organic framework; and
an interface crystalline layer, disposed between the metal oxide support and the metal organic framework, wherein the interface crystalline layer has a d-spacing of 0.290 nm to 0.360 nm.

2. The composite material as claimed in claim 1, wherein at least a portion of a surface of the metal oxide support is covered by the interface crystalline layer.

3. The composite material as claimed in claim 1, wherein the metal oxide support comprises aluminium oxide, zirconium oxide, cerium oxide or a combination thereof.

4. The composite material as claimed in claim 1, wherein the metal oxide support is a non-porous structure, and a median particle size thereof is 10 μm to 150 μm.

5. The composite material as claimed in claim 1, wherein the metal oxide support is a porous structure, and a pore size thereof is 10 nm to 180 nm.

6. The composite material as claimed in claim 1, wherein the metal oxide support is a porous structure, and a specific surface area thereof is 1 m²/g to 500 m²/g.

7. The composite material as claimed in claim 1, wherein the metal oxide support is a porous structure, and a pore volume thereof is 0.002 cm³/g to 0.3 cm³/g.

8. The composite material as claimed in claim 1, wherein a weight ratio of the metal organic framework to the composite material is 0.1:100 to 50:100.

9. The composite material as claimed in claim 1, wherein the metal organic framework comprises:
a metal ion and an organic ligand,
wherein a metal of the metal ion is selected from copper, aluminum, iron, zinc or a combination thereof; and
the organic ligand comprises at least one benzene ring and at least two carboxyl groups.

10. The composite material as claimed in claim 9, wherein the organic ligand comprises at least one amino group.

11. The composite material as claimed in claim 1, wherein a thickness of the interface crystalline layer is 10 nm to 340 nm.

12. A composite material preparation method, comprising:
adding a metal oxide support into a base solution at a first temperature and a pressure to form a first mixed solution;
introducing an organic linking agent and a metal ion precursor into the first mixed solution at the first temperature and the pressure to react and form a second mixed solution;
filtering the second mixed solution to obtain a solid product of the composite material as claimed in claim 1.

13. The composite material preparation method as claimed in claim 12, further comprising drying the solid product at a second temperature to obtain the composite material according to claim 1.

14. The composite material preparation method as claimed in claim 12, wherein the first temperature ranges from 15° C. to 50° C.

15. The composite material preparation method as claimed in claim 13, wherein the second temperature ranges from 60° C. to 90° C.

16. The composite material preparation method as claimed in 12, wherein the pressure ranges from 0.5 bar to 10 bar.

17. The composite material preparation method as claimed in claim 12, wherein the metal oxide comprises aluminium oxide, zirconium oxide, cerium oxide or a combination thereof.

18. The composite material preparation method as claimed in claim 12, wherein the metal ion precursor comprises copper salt, aluminum salt, iron salt, zinc salt or a combination thereof.

19. The composite material preparation method as claimed in claim 12, wherein the organic linking agent comprises trimesic acid, 2-aminoterephthalic acid or a combination thereof.

20. The composite material preparation method as claimed in claim 12, wherein a molar ratio of the metal oxide support to the metal ion precursor is from 1:20 to 1:500, and a molar ratio of the metal ion precursor to the organic linking agent is from 77:100 to 100:100.

21. A heteroatom removing method, comprising:
filling a reactor with the composite material as claimed in claim 1;
introducing a heteroatom-containing liquid organic matter into the reactor; and
adsorbing a heteroatom in the heteroatom-containing liquid organic matter by contacting the composite material with the heteroatom-containing liquid organic matter, wherein the heteroatom comprises silicon, phosphorus, bromine, chlorine, nitrogen or a combination thereof.

22. The heteroatom removing method as claimed in claim 21, wherein the liquid organic matter comprises a waste plastic pyrolysis oil, a liquid biomass, a liquid food, a liquid waste or a combination thereof.

23. The heteroatom removing method as claimed in claim 21, further comprising: washing the composite material by bringing the composite material into contact with an organic solvent; and
refilling the composite material back into the reactor.
